(19) United States
(12) Patent Application Publication
(10) Pub. No.: US 2006/0038319 A1
(43) Pub. Date: Feb. 23, 2006

(54) Method and apparatus for manufacturing composite product

(75) Inventors: Tsuyoshi Arai, Kariya-city (JP); Naoki Hiraiwa, Toyokawa-city (JP); Hiroshi Tanimura, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/194,478

(22) Filed: Aug. 2, 2005

(30) Foreign Application Priority Data
Aug. 4, 2004 (JP) 2004-228045

(51) Int. Cl. B28B 5/00; B29C 45/14; B28B 7/22; B29C 45/20

(52) U.S. Cl. 264/251; 425/575; 264/242; 264/255

(57) ABSTRACT

A molding die accommodates a first member having a through-hole and a second member in such a manner that the first member and the second member are in contact with each other to form a filling chamber therebetween. The filling chamber communicates to the through-hole. The molding die includes a material passage through which a melted material flows. The material passage is connected to the through-hole. The melted material is introduced into the filling chamber while the molding die is brought into closely contact with the first member at an area where is around the material passage and the through-hole.

### CROSS REFERENCE TO RELATED APPLICATIONS

This application is based on and incorporates herein by reference Japanese Patent Application No. 2004-228045 filed on Aug. 04, 2004, the disclosure of which is incorporated herein by reference.

### FIELD OF THE INVENTION

The present invention relates to a method and apparatus for manufacturing a composite product which has two parts connected with each other.

### BACKGROUND OF THE INVENTION

JP-62-87315A shows a method in which two parts are connected with each other by welding to enhance an accuracy of relative position thereof, a sealingness therebetween, and a connecting strength therebetween.

FIG. 12A and 12B show a conventional method in which a first member 1 and a second member 2 are connected by welding. The first member 1 has an inlet opening 3. The first member 1 and the second member 2 are confronted to each other to form a filling chamber 4 therebetween. The inlet opening 3 communicates to the filling chamber 4. A welded material is introduced into the filling chamber 4 through a gate 6 and the inlet opening 3. When the welded material is solidified, the first member 1 and the second member 2 are connected with each other.

However, since the gate 6 is formed on contacting surface in which the molding die 5 confronts to the first member 1, the molding die 5 is not in contact with the first member 5 at a non-contacting area 7 where the gate 6 is provided. Thus, due to the pressure of the welded material in the non-contacting area 7, the first member 1 moves away from the molding die 5 to form a clearance 8 between the first member 1 and the molding die 5. The welded material may flows into the clearance 8 as shown in FIG. 12B. Furthermore, the welded material in the gate 6 may flow into a clearance 9 formed between the first member 1, the second member 2 and the molding die 5. Such a welded material in the clearances 8, 9 becomes fins so that a deformation of the members 1, 2 is induced. That is, the accuracy of relative position of the first and second members 1, 2, is deteriorated, and a sealingness and a connecting strength therebetween are deteriorated.

### SUMMARY OF THE INVENTION

The present invention is made in view of the foregoing matter and it is an object of the present invention to provide a method and apparatus which is capable of precisely manufacturing a composite product in low productive cost.

According to the present invention, a first member is brought into contact with a second member to form a filling chamber therebetween. The first member includes a through-hole which communicates to the filling chamber. A material passage formed in a molding die is connected to the through-hole in order to introduce a melted material into the filling chamber while the molding die is in closely contact with the first member at an area where is around.

### BRIEF DESCRIPTION OF THE DRAWINGS

The above and other objects, features, and advantages of the present invention will become more apparent from the following detailed description made with reference to the accompanying drawings, in which like parts are designated by like reference number and in which:

FIG. 1A and 1B are cross sectional view of a throttle apparatus according to an embodiment of the present embodiment;

FIG. 2 is a perspective view of the throttle apparatus according to the embodiment of the present embodiment;

FIG. 3 is a perspective view of the throttle apparatus without a driving-unit cover;

FIG. 4 is a flowchart for explaining a manufacturing method of the throttle apparatus according to the embodiment of the present invention;

FIG. 5 is a perspective view of a driving-unit cover partially notched according to the embodiment of the present invention;

FIG. 6 is a perspective view of a resin-molding product according to the embodiment of the present invention;

FIG. 7 is a cross sectional view of a welding machine used for manufacturing the throttle apparatus according to the embodiment of the present invention;

FIG. 8 is a cross sectional view of the welding machine for explaining a manufacturing method of the throttle apparatus according to the embodiment of the present invention;

FIGS. 9A and 9B are cross sectional views for explaining the manufacturing method of the throttle apparatus according to the embodiment of the present invention;

FIG. 10A and 10B are cross sectional views of another embodiment of the present invention;

FIG. 11A and 11B are cross sectional views of the other embodiment of the present invention; and

FIG. 12A and 12B are cross sectional views for explaining a conventional manufacturing method of a composite product.

### DETAILED DESCRIPTION OF THE PREFERRED EMBODIMENTS

An embodiment of the present invention will be described hereinafter with reference to the drawings.

FIG. 2 is a perspective view of a throttle apparatus 10 as a composite product. The throttle apparatus 10 is mounted on a vehicle and includes a throttle valve 16. The throttle valve 16 adjusts an amount of intake air to an internal combustion engine.

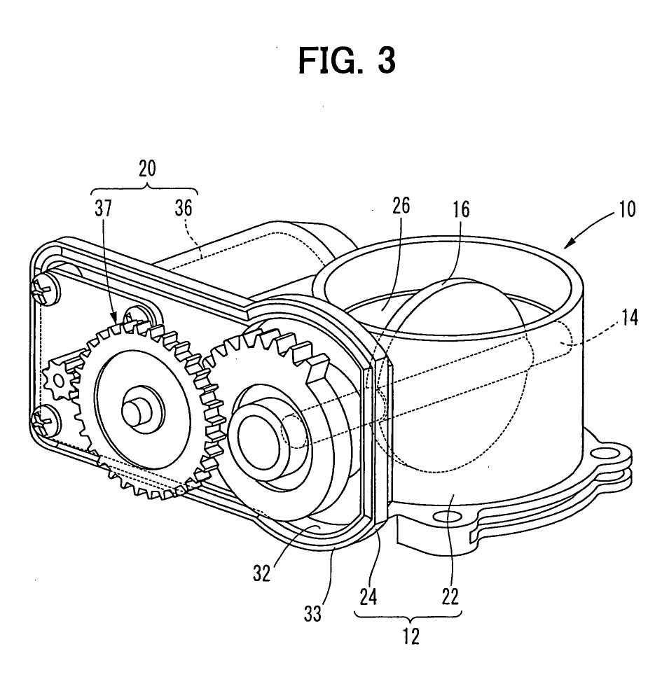

FIG. 3 is a perspective view of the throttle apparatus 10 in which a driving-unit cover 18 in FIG. 2 is removed. The throttle apparatus 10 includes a throttle body 12, a throttle shaft 14, a throttle valve 16, a driving-unit 20, and the driving-unit cover 18.

The throttle body 12 includes a cylindrical body 22 and a driving-unit case 24, which are made of resin material. The cylindrical body 22 has an intake air passage 26 therein and rotatably supports the throttle shaft 14 at both end portions thereof. The throttle shaft 14 is made of metallic material and comes across a center axis of the cylindrical body 22 in a right angle. A middle portion of the throttle shaft 14 is insert molded in the throttle valve 16 to rotate therewith. The clearance between the throttle valve 16 and the cylindrical body 22 is varied according to a rotation of the throttle shaft 14 in order to adjust the intake air amount.

The driving-unit case 24 as a second member is made of resin integrally with the body 22. The driving-unit case 24 has an opening 32 and a flange 33. The driving-unit cover 18 as a first member is made of resin material and has a flange 35. The flange 33 and the flange 35 are confronted to each other and are connected by welding. An angle sensor (not shown) for detecting the rotational angle of the throttle shaft 14 is inserted in an inner wall of the driving-unit cover 18. The driving unit 20 is accommodated in a space formed between the deriving-unit case 24 and the driving-unit cover 18. The driving-unit 20 includes an electric motor 36 and a gear mechanism 37. A torque generated by the electric motor 36 is transferred to the throttle shaft 14 through the gear mechanism 37.

It is necessary to enhance an accuracy of relative position between the driving-unit cover 18 and the driving-unit case 24 in order to precisely position the angle sensor relative to the throttle shaft 14. It is necessary to enhance a sealingness between the driving-unit cover 18 and the driving-unit case 24 in order to protect the angle sensor from water. Furthermore, it is necessary to enhance a connecting strength therebetween in order to endure a vibration of the vehicle.

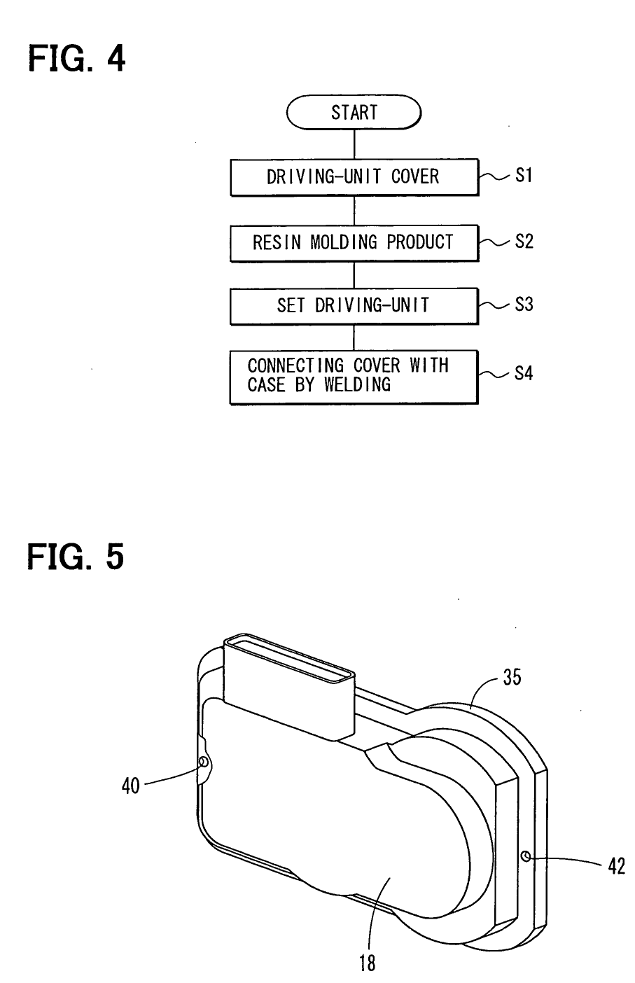

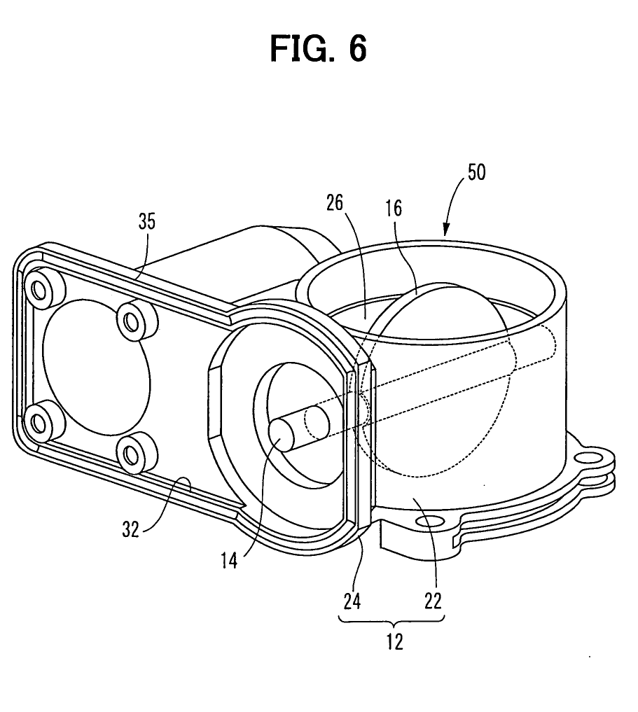

Referring to FIG. 4, a method for manufacturing the throttle apparatus 10 will be described hereinafter.

In step S1, the driving-unit cover 18 is molded, which has an inlet opening 40 (a through-hole) and an outlet opening 42 (a through-hole) as shown in FIG. 5. The angle sensor (not shown) is inset-molded in the driving-unit cover 18. The driving-unit cover 18 may be molded in single step. Alternatively, a blank having no inlet and outlet openings is molded, and then the inlet opening 40 and the outlet opening 42 are formed by cutting or grinding. Step S1 corresponds to a first member molding step.

In step S2, a resin-molding product 50 is molded, which includes the throttle valve 16, the throttle shaft 14 and the throttle body 12. The resin-molding product may be molded in single step. Alternatively, after the throttle shaft 14 is insert molded in the throttle valve 16, the throttle body 12 supporting the throttle shaft 14 molded. Step S2 corresponds to a second member molding step.

The processing order of step S1 and step S2 can be changed, or step S1 and step S2 can be executed simultaneously.

In step S3, the driving-unit 20 is mounted on the driving-unit case 24 as shown in FIG. 3.

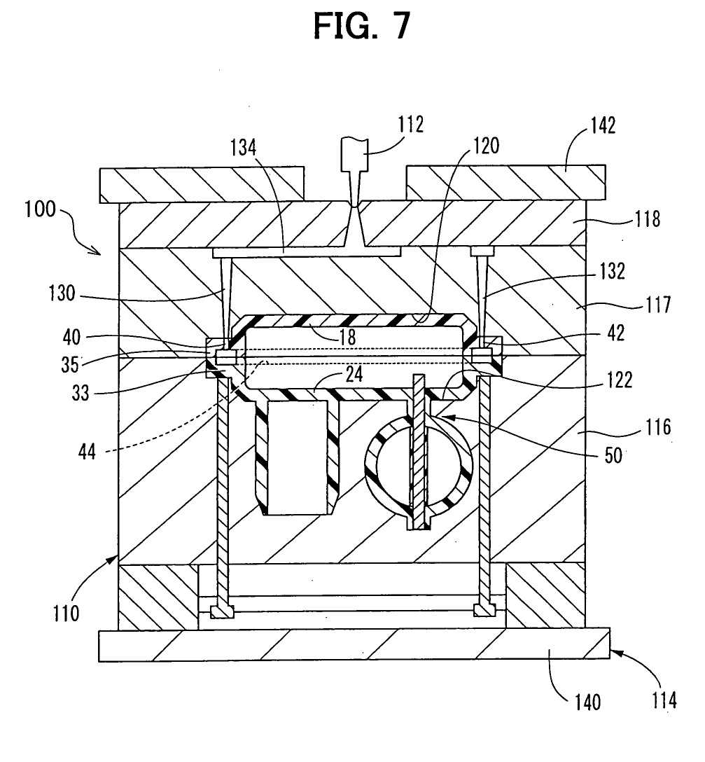

In step S4, a welding machine 100 shown in FIG. 7 connects the driving-unit cover 18 with the driving-unit case 24 by welding to fabricate the throttle apparatus 10 shown in FIG. 2.

A structure of the welding machine 100 is described hereinafter.

The welding machine 100 includes the molding die 110, an injection-molding machine 112 supplying a resin material into the molding die 110, and a clamping mechanism 114 clamping/releasing the molding die 114.

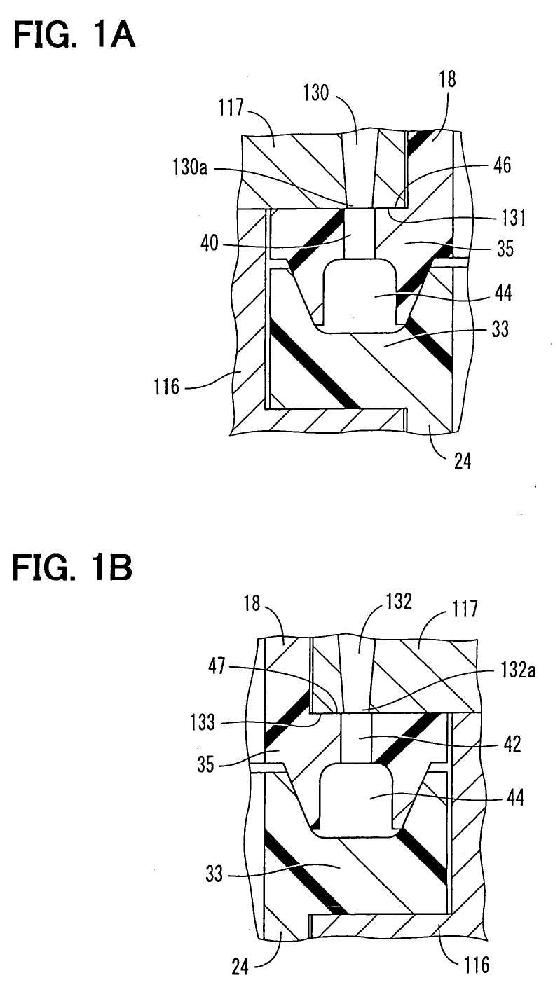

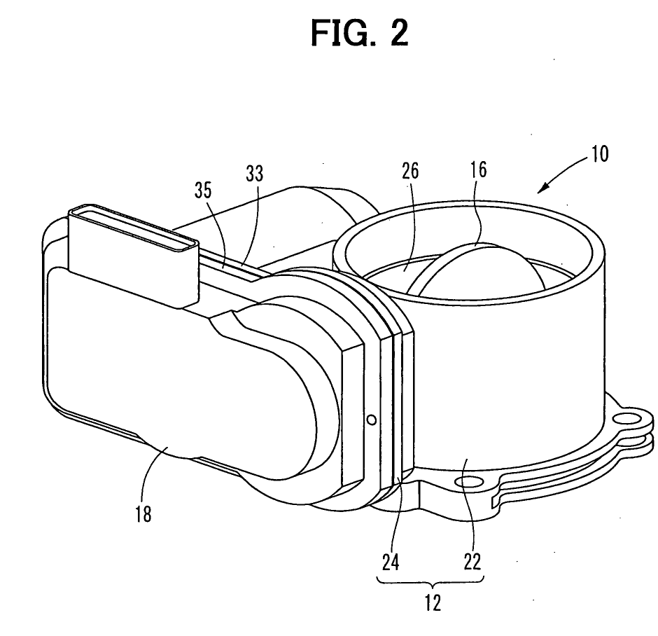

The molding die 110 includes a plurality of die plates 116, 117, 118 which form a first cavity 120 and a second cavity 122 therein. The driving-unit cover 18 is accommodated in the first cavity 120 in such a manner that an inner wall surface of the driving-unit cover 18 confronts to the second cavity 122. The resin mold product 50 is accommodated in the second cavity 122 in such a manner that the opening 32 of the driving-unit case 24 confronts to the first cavity 120. As shown in FIGS. 1 and 7, the driving-unit cover 18 and the driving-unit case 24 are arranged in the first cavity 120 and the second cavity 122 in such a manner that the flange 33 and the flange 35 are contact with each other. A filling chamber 44 is formed between the flange 33 and the flange 35. The filling chamber 44 has a doughnut shape and communicates to the inlet opening 40 and the outlet opening 42.

A gate 130 is provided in the die plate 117. The gate 130 connects a runner 134 with the inlet opening 40. The gate 130 is for introducing a resin material from the injection-molding machine 112 into the filling chamber 44 through the inlet opening 40. The gate 130 is tapered toward a connecting edge portion 130a. That is, the inner diameter of the gate 130 decreases toward the connecting edge portion 130a. As shown in FIG. 1A, an inner wall surface 131 of the die plate 117 is in contact with an outer wall surface 46 of the flange 35 by surface contact.

An overflow passage 132 is provided in the die plate 117. The overflow passage 132 communicates to the outlet opening 42. An overflowed resin material flows into the overflow passage 132 through the outlet opening 42. The overflow passage 132 is tapered toward a connecting edge portion 130b. That is, the inner diameter of the overflow passage 132 decreases toward the connecting edge portion 130b. As shown in FIG. 1B, an inner wall surface 133 of the die plate 117 is contact with an outer wall surface 47 of the flange 35 by surface contact.

The clamping mechanism 114 includes a fixed plate 140 and a movable plate 142. The clamping mechanism 114 can clamp the die plates 116, 117, 118 and releases the clamping of the die plates 116, 117, 118.

The process in step S4 is described in detail hereinafter. At first, the die plates 116, 117, 118 are clamped in such a manner that the driving-unit cover 18 and the resin-molding product 50 are accommodated in the first and the second cavity 120, 122. The flange 35 and the flange 33 are brought into contact with each other to form the filling chamber 44 therebetween. The filling chamber communicates to the inlet opening 40 and the outlet opening 42. The inner wall surfaces 131, 133 of the die plate 117 come into contact with the outer wall surfaces of the flange 35 to communicate the gate 130 and the overflow passage 132 are respectively connected to the inlet opening 40 and the outlet opening 42.

The inner wall surface 131 of the die plate 117 is in closely contact with the outer wall surface 46 at an area where is around the gate 130 and the inlet opening 40. The inner wall surface 133 of the die plate 117 is in closely contact with the outer wall surface 46 at an area where is around the overflow passage 132 and the outlet opening 42. Under such an arrangement, the injection-molding machine 112 injects melted resin into the runner 134. The injected resin flows into the filling chamber 44 through the gate 130 and the inlet opening 40. When the filling chamber 44 is filled with the melted resin, surplus resin flows into the overflow passage 132 through the outlet opening 42.

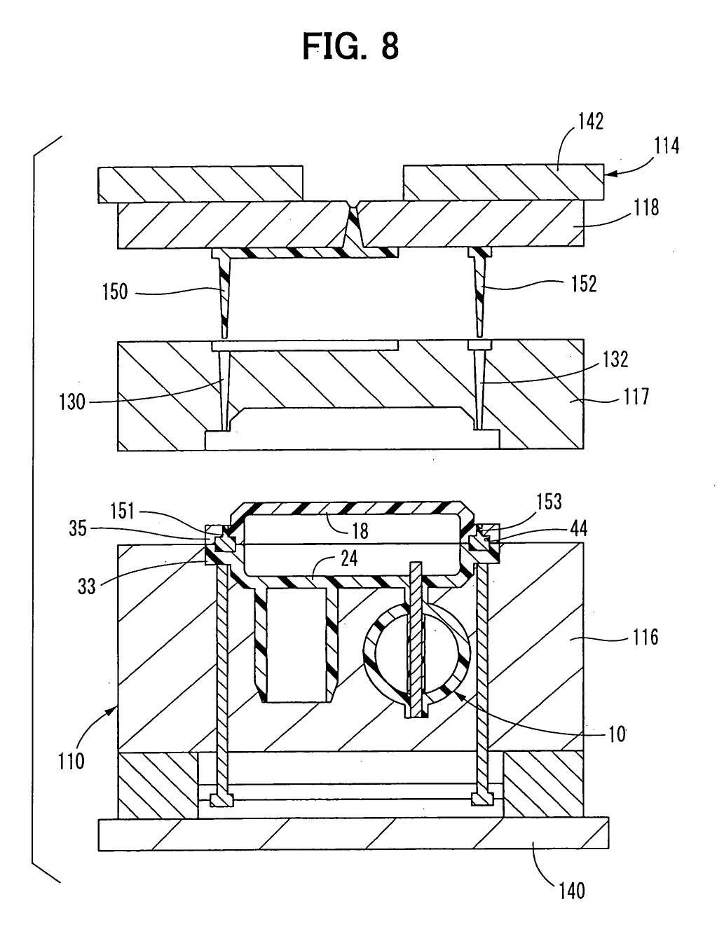

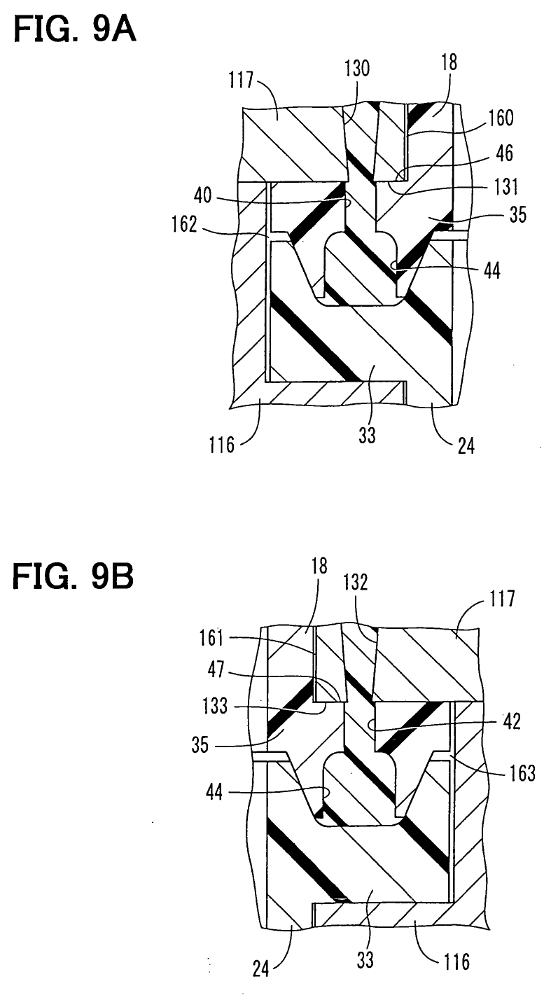

After the melted resin in the filling chamber 44, the gate 130, and the overflow passage 132 is cooled and solidified, the clamped die plates 116, 117, 118 are released. As shown in FIG. 8, the die plates 117, 118 are relatively moved away from the driving-unit cover 18, whereby solidified resin 150 in the gate 130 is separated from solidified resin 151 in the inlet opening 40, and the solidified resin 152 in the overflow passage 132 is separated from solidified resin 153 in the outlet opening 42.

Step S4 described above corresponds to a filling chamber forming step and a material filling step.

According to the present embodiment, the inner wall surface 131 of the die plate 117 is in closely contact with the outer wall surface 46 at an area where is around the gate 130 and the inlet opening 40. The inner wall surface 133 of the die plate 117 is in closely contact with the outer wall surface 46 at an area where is around the overflow passage 132 and the outlet opening 42. Thus, the melted resin hardly flows into a clearance between the die plate 117 and the driving-unit cover 18. It is restricted the melted resin from flowing into clearances 160, 161 between the cover 18 and the die plate 117 and clearances between the cover 18, case 24, and die plates 116, 117. The relative position between the cover 18 and the case 24 are precisely maintained, and the sealingness and the contacting strength are enhanced.

According to the present embodiment, the solidified resin 150, 151 in the gate 130 and the overflow passage 132 are easily removed from the solidified resin 152, 153, so that product steps are reduced compared with the conventional apparatus.

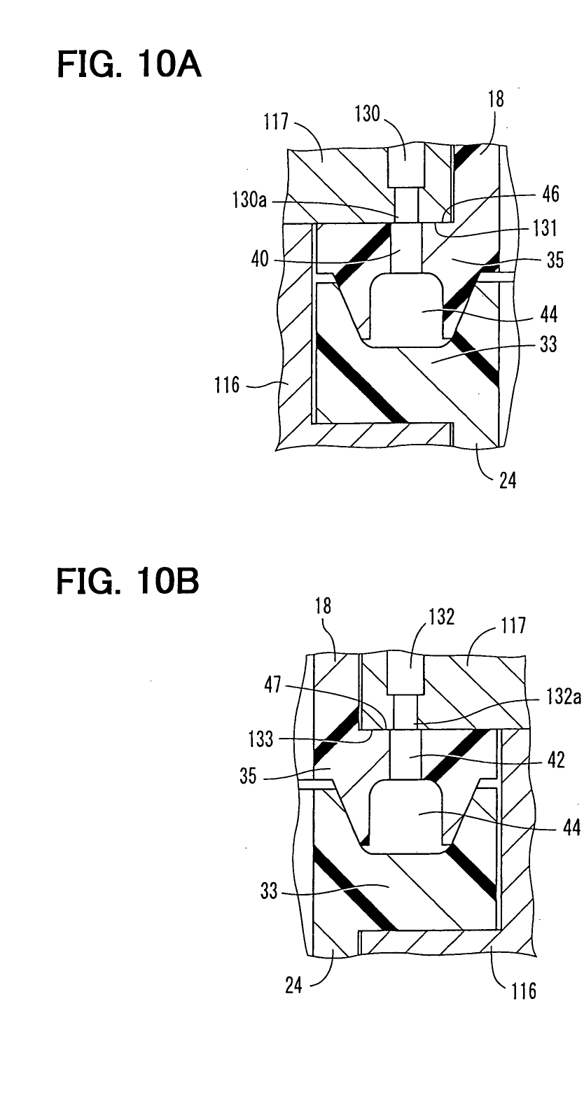

FIG. 10A and 10B show another embodiment. In this embodiment, the gate 130 and the overflow passage 132 are cylindrically shaped having a step. That is, the connecting end portions 130a and 132a have smaller diameter than the other portions. Alternatively, whole of the gate 130 and the overflow passage 132 can be cylindrically shaped.

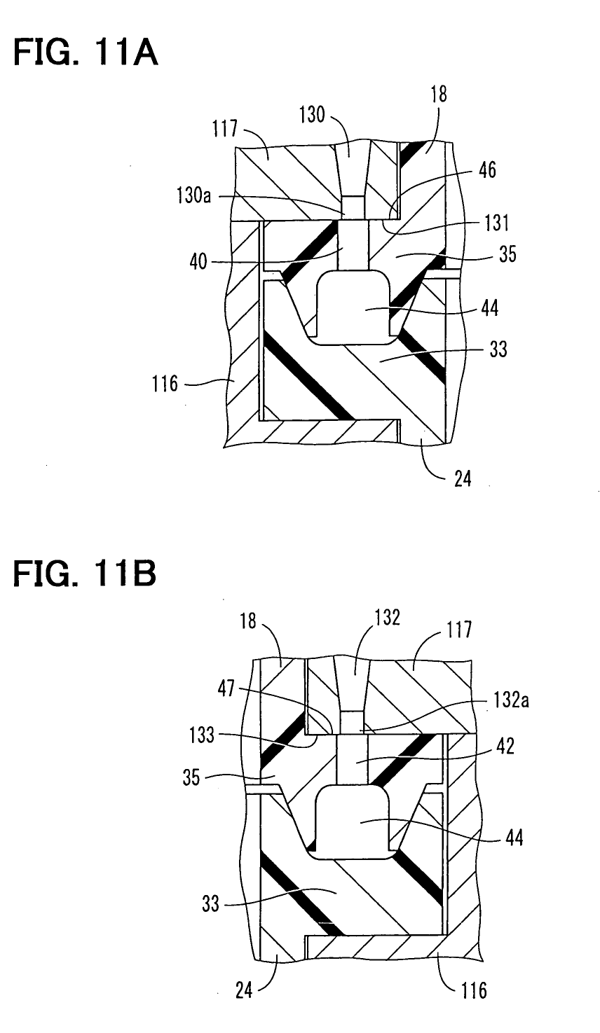

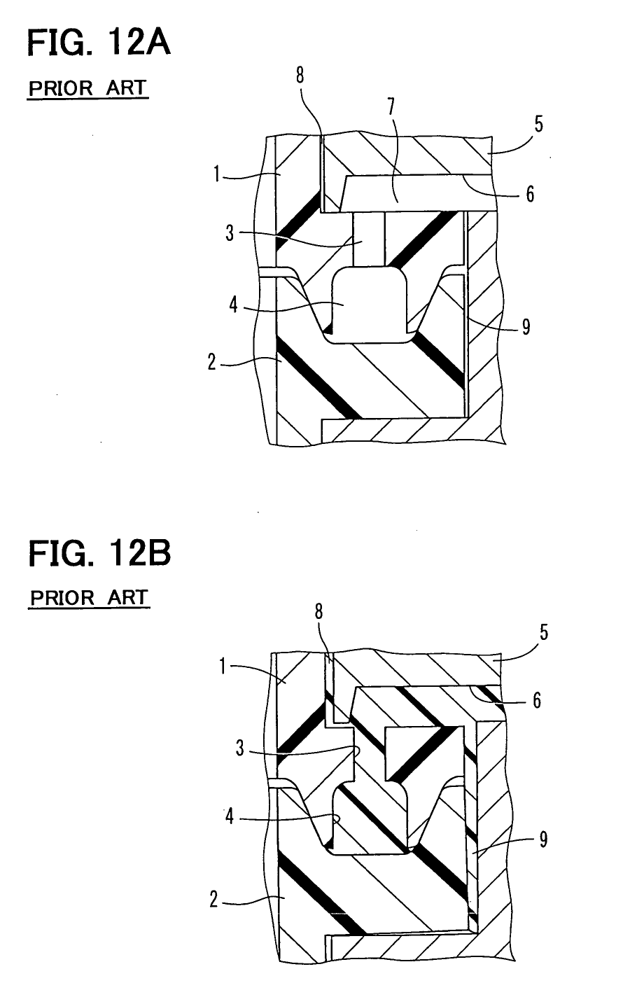

FIG. 11A and 11B show the other embodiment, in which the connecting end portions 130a and 132a have a cylindrical shape, and the other portions are tapered toward the connecting end portions 130a, 130b.

Alternatively, a slide core siding perpendicularly to a die opening direction may be used in order to remove the solidified resin 151, 153.

The present invention can be applied to manufacturing composite products other than the throttle apparatus.

What is claimed is:

1. A method for manufacturing a composite product having a first member and a second member, the method comprising:
forming a first member having a through-hole;
forming a second member;
bringing the first member in contact with the second member to form a filling chamber between contacting surfaces of the first member and the second member, the filling chamber communicating to the through-hole;
connecting the through-hole with a material passage provided in a molding die;
supplying a melted material into the filling chamber through the material passage and the through-hole while the molding die is in closely contact with the first member at an area where is around the material passage and the through-hole; and
solidifying the melted material in the filling chamber in order to connect the first member with the second member.

2. The method for manufacturing a composite product according to claim 1, wherein
the melted material is supplied into the filling chamber through the material passage which is tapered toward a connecting end portion to the penetrated opening.

3. The method for manufacturing a composite product according to claim 1, wherein
the melted material is supplied into the filling chamber through a gate as the material passage and an inlet opening as the through-hole.

4. The method for manufacturing a composite product according to claim 1, wherein
a surplus melted material in the filling chamber flows out into an overflow passage as the material passage through an outlet opening as the through-hole.

5. An apparatus for manufacturing a composite product having a first member and a second member, the apparatus comprising:
a molding die accommodating a first member having a through-hole and a second member in such a manner that the first member and the second member are in contact with each other to form a filling chamber therebetween, the filling chamber communicating to the through-hole; wherein
the molding die includes a material passage through which a melted material flows,
the material passage is connected to the through-hole, and
the melted material is introduced into the filling chamber while the molding die is brought into closely contact with the first member at an area where is around the material passage and the through-hole.

6. The apparatus for manufacturing a composite product according to claim 5, wherein
the material passage is tapered toward a connecting end portion to the through-hole.

7. The apparatus for manufacturing a composite product according to claim 5, wherein
the melted material is introduced into the filling chamber through a gate as the material passage and an inlet opening as the through-hole.

8. The apparatus for manufacturing a composite product according to claim 5, wherein
a surplus melted material in the filling chamber flows out into an overflow passage as the material passage through an outlet opening as the through-hole.
